(19) United States
(12) Patent Application Publication
(10) Pub. No.: US 2016/0378262 A1
(43) Pub. Date: Dec. 29, 2016

(54) Detection Method, Device And System For Detecting Self-Capacitance Touch Screen

(71) Applicant: FocalTech Electronics, Ltd., Grand Cayman (KY)

(72) Inventors: Lianghua MO, Shenzhen (CN); Weiping LIU, Shenzhen (CN)

(73) Assignee: FocalTech Electronics, Ltd., Grand Cayman (KY)

(21) Appl. No.: 15/261,466

(22) Filed: Sep. 9, 2016

Related U.S. Application Data
(63) Continuation-in-part of application No. 13/596,837, filed on Aug. 28, 2012, now abandoned.

(30) Foreign Application Priority Data
Jun. 21, 2012 (CN) 201210212641.4

(51) Int. Cl. G06F 3/041; G06F 3/044

(52) U.S. Cl. CPC G06F 3/0418; G06F 3/044

(57) ABSTRACT

It is provided a self-capacitance touch screen detection method, device and system. The method includes: receiving a scanning waveform by a currently detected channel of a self-capacitance touch screen; inputting the voltage of the scanning waveform into an input terminal of a voltage following unit, and driving at least a preset channel that is adjacent to the currently detected channel of the self-capacitance touch screen via an output terminal of the voltage following unit; and calculating self-capacitance touch screen coordinate data for a touch in the currently detected channel. The method not only avoids the disturbance to the detection for a touch in the currently detected channel generated due to water vapor or a water droplet, but also obtains an increased relative change generated by the same touch, and thereby the detection sensibility of the self-capacitance touch screen is improved.

### CROSS-REFERENCE TO RELATED APPLICATIONS

This application is a continuation-in-part of U.S. patent application Ser. No. 13/596,837, filed on Aug. 28, 2012, which claims priority benefit of Chinese patent application No. 201210212641.4 titled “DETECTION METHOD, DEVICE AND SYSTEM FOR DETECTING SELF-CAPACITANCE TOUCH SCREEN”, filed with the Chinese State Intellectual Property Office on Jun. 21, 2012. The entire disclosures of the above applications are incorporated herein by reference.

### FIELD OF THE INVENTION

The present invention relates to the field of detection technique for a capacitive screen, and in particular to a detection method, device and system for a self-capacitance touch screen.

### BACKGROUND OF THE INVENTION

Portable terminals such as mobile phones, tablet personal computers are widely used today. As the most commonly used screens for the portable terminals at the current stage, the capacitive touch screen is popular due to its high sensitivity and smooth operation. The capacitive touch screen includes surface capacitive style and projected capacitive style, and the projected capacitive style may be divided into two implementing styles, i.e. a self-capacitance style and a mutual-capacitance style, according to its detection method.

Self-capacitance detection determines the occurrence of a touch event according to an increase in the capacitance of a detection channel to the ground, i.e. an increment of the capacitance to the ground. A channel M in FIG. 1 is taken as an example, the equivalent capacitance to the ground is C0 before touching (see FIG. 1), explanation will be made in conjunction with FIG. 2, in the case when there is a human touch at the position of channel M and channel N (channel N is a channel adjacent to channel M) and a detection is performed on to channel M, capacitance C_{tM} and capacitance C_{tN} are formed in an overlapping region by the human, channel M and channel N, and since the human body is grounded, channel M and channel N are added with additional capacitances C_{M} and C_{N} to the ground respectively when the touch occurs. The equivalent capacitance to the ground after the touch occurs is capacitance C_{tM} in parallel with capacitance C_{M}. By detecting the capacitance change occurred which is in direct proportion to the overlap area of the touch region, an X-axis coordinate for the occurrence of the touch can be obtained. Then the positions of channel M and channel N on the screen is obtained by detection to obtain a Y-axis coordinate, thereby the position for the occurrence of the touch can be obtained. However, when detecting, if the surface of the capacitive screen suffers from disturbances due to external moist air or a water droplet, a problem will take place that the detected coordinate data is inaccurate.

Explanation is made in conjunction with FIG. 3, in the example, channel M is disturbed by a water droplet P and the other channels are grounded. Equivalent capacities C3 and C4 are formed by the water droplet P and the channels M and N. The increment

$$Δ C = \frac{{C}_{3} * {C}_{4}}{{C}_{3} + {C}_{4}}$$

of the equivalent capacitance to the ground is generated at channel M. Due to the occurrence of the capacitance increment ΔC, a detection device may determine that there is a touch event occurred in the region with the water droplet of channel M, and thereby the coordinate calculation performed when there is a touch event really occurred between channel M and channel N is affected.

Similarly, explanation is made in conjunction with FIG. 4, in the example, when detection is performed for channel M there is disturbance by water droplet P and the other channels are floating. Equivalent capacities C3 and C4 are formed by water droplet P and the channels M and N. The increment

$$Δ C = \frac{( \frac{{C}_{3} * {C}_{4}}{{C}_{3} + {C}_{4}} + {C}_{1} ) * {C}_{2}}{\frac{{C}_{3} * {C}_{4}}{{C}_{3} + {C}_{4}} + {C}_{1} + {C}_{2}} - \frac{{C}_{1} * {C}_{2}}{{C}_{1} + {C}_{2}}$$

of the equivalent capacitance to the ground is generated at the channel M. When C2 is infinitely large,

$$Δ C = \frac{{C}_{3} * {C}_{4}}{{C}_{3} + {C}_{4}} ,$$

this is equivalent to the case in which channel N is grounded; or when C2=0, ΔC=0, namely the capacitance of channel N to the ground is 0, which is actually impossible. In both of the above cases, the water droplet can bring about additional capacitance. That is to say the above problem still exists.

According to the above analysis, there are the following disadvantages in the existing detection technology: when detection is performed on a channel of a capacitive screen, the coordinate data for the occurred touch can not be detected accurately if there is water vapor or a water droplet on the screen. Secondly, since there is a capacitance C1 between channels (in FIG. 3) or a series capacitance (in FIG. 4) of C1 and C2, the capacitance of the detection channel to the ground is increased, thereby the relative change of the capacitance to the ground caused by the same touch becomes smaller and the detection sensibility of the self-capacitance touch screen is reduced.

### SUMMARY OF THE INVENTION

In view of the above, the present invention provides a detection method, device and system for a self-capacitance touch screen, so that channel touch coordinate data can be detected accurately when a screen suffers from disturbance of water vapor or a water droplet, and the capacitance of the scanning channel to the ground is decreased, thereby the detection sensibility of the self-capacitance touch screen is improved.

A method for detecting a capacitive touch screen includes:

receiving a scanning waveform by a currently detected channel of a self-capacitance touch screen;

inputting the voltage of the scanning waveform into an input terminal of a voltage following unit, and driving at least a preset channel that is adjacent to the currently detected channel of the self capacitive touch screen via an output terminal of the voltage following unit; and

calculating self-capacitance touch screen coordinate data for a touch in the currently detected channel.

In order to make the above solution perfect,

the number of the voltage following unit is single.

The driving a preset channel that is adjacent to the currently detected channel of the self capacitive touch screen via an output terminal of the voltage following unit specifically includes:

driving all the channels of the self capacitive touch screen except the currently detected channel of the self capacitive touch screen via an output terminal of the voltage following unit.

In order to make the above solution perfect, when the voltage following unit is an amplifier whose magnification factor is 1:

an in-phase terminal of the amplifier is connected to the currently detected channel of the self-capacitance touch screen; and

a reversed-phase terminal of the amplifier is connected to an output terminal of the amplifier and is at the same time connected to at least the preset channel that is adjacent to the currently detected channel of the self capacitive touch screen.

A detection device for a capacitive touch screen includes:

a detection scanning waveform generating unit configured to send a scanning waveform to a currently detected channel of a self capacitive touch screen;

a voltage following unit, wherein the voltage of the scanning waveform is input into an input terminal of the voltage following unit, an output terminal of the voltage following unit is connected to at least a preset channel that is adjacent to the currently detected channel of the self-capacitance touch screen, and the voltage following unit is configured to drive a preset channel that is adjacent to the currently detected channel of the self-capacitance touch screen by utilizing the scanning waveform; and

a calculating unit configured to calculate self-capacitance touch screen coordinate data for a touch in the currently detected channel.

In order to make the above solution perfect, the number of the voltage following unit is single.

In order to make the above solution perfect, the output terminal of the voltage following unit is connected to all the channels of the self-capacitance touch screen except the currently detected channel of the self-capacitance touch screen.

In order to make the above solution perfect, the voltage following unit is specifically implemented as followed: an amplifier whose magnification factor is 1, an in-phase terminal of the amplifier is connected to the currently detected channel of the self-capacitance touch screen; and an reversed-phase terminal of the amplifier is connected to an output terminal of the amplifier and is at the same time connected to at least the preset channel that is adjacent to the currently detected channel of the self-capacitance touch screen.

A detection system for a self-capacitance touch screen which includes the above detection device.

As can be seen from the above technical solution, in the detection method, device and system according to the embodiments of the present invention, when a current channel is detected, the scanning waveform drives at least the preset channel that is adjacent to the currently detected channel of the self-capacitance touch screen via the voltage following unit. The voltage of the currently scanned channel and the voltage of each of the channels in the region which is disturbed by water change simultaneously. When the self-capacitance touch screen suffers from the disturbance generated due to the water vapor or the water droplet, the voltage difference across the equivalent capacitance increment ΔC of the currently detected channel generated due to disturbance by the water vapor or the water droplet does not change. That is to say, no influence by the equivalent capacitance to the ground is introduced during the detection. Thereby the disturbance to the detection for a touch in the currently detected channel of the touch screen generated due to the water vapor or the water droplet is avoided. Secondly, since the voltage difference across the capacitance between the currently detected channel of the self-capacitance touch screen and a adjacent scanning channel also dose not change, the initial capacitance of the currently detected channel of the self-capacitance touch screen to the ground is decreased, and thereby the relative change generated due to the same touch is increased, so that the detection sensibility of the self-capacitance touch screen is improved.

### BRIEF DESCRIPTION OF THE DRAWINGS

The accompany drawings needed to be used in the description of the embodiments or the prior art will be described briefly as follows, so that the technical solutions according to the embodiments of the present invention or according to the prior art will become more clearer. It is obvious that the accompany drawings in the following description are only some embodiments of the present invention. For those skilled in the art, other accompany drawings may be obtained according to these accompany drawings without any creative work.

FIGS. 1-4 are schematic diagrams of existing detection for a capacitive touch screen disclosed in an embodiment of the present invention;

FIG. 5 is a flow chart of a detection method for the capacitive touch screen according to an embodiment of the present invention;

FIG. 6 is a flow chart of a detection method for the capacitive touch screen according to another embodiment of the present invention;

FIG. 7 is a structural schematic diagram of a detection device for the capacitive touch screen according to an embodiment of the present invention;

FIG. 8 is a schematic diagram of a detection state for the capacitive touch screen according to an embodiment of the present invention; and

FIG. 9 is a schematic diagram of a voltage following unit of the capacitive touch screen according to an embodiment of the present invention.

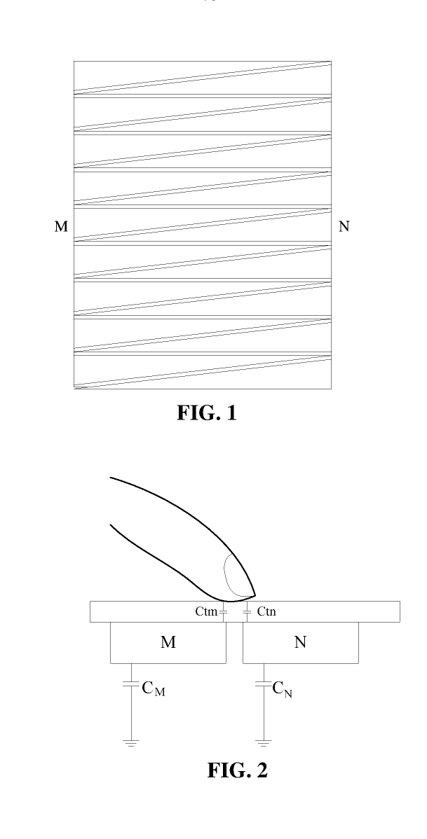

### DETAILED DESCRIPTION OF THE INVENTION

The technical solution according to the embodiments of the present invention will be described clearly and completely as follows in conjunction with the accompany drawings in the embodiments of the present invention. It is obvious that the described embodiments are only a part of the embodiments according to the present invention. All the other embodiments obtained by those skilled in the art based on the embodiments in the present invention without any creative work belong to the scope of the present invention.

The embodiments of the present invention disclose a detection method for a self-capacitance touch screen, device and system, which are capable of accurately detecting channel touch coordinate data when a screen suffers from disturbance of water vapor or a water droplet, and reducing the capacitance of the scanning channel to the ground, thereby the detection sensibility of the self-capacitance touch screen is improved.

FIG. 5 shows a detection method for a capacitive touch screen which includes the following steps.

Step 51: a currently detected channel of a self-capacitance touch screen receives a scanning waveform;

The scanning waveform is a scanning voltage for detecting the currently detected channel of the self-capacitance touch screen. Detail description will be given in conjunction with the channel M in FIG. 2.

Step 52: the voltage of the scanning waveform is input into an input terminal of a voltage following unit, and at least a preset channel that is adjacent to the currently detected channel of the self-capacitance touch screen is driven via an output terminal of the voltage following unit.

For the simplicity of the whole detection circuit and for the sake of cost, the detection circuit is driven by one voltage following unit.

Besides channel M, the preset channel that is adjacent to the currently detected channel of the self-capacitance touch screen receives at the same time the high frequency alternating current voltage and the voltage changes equally. The preset channel for the currently detected channel of the self-capacitance touch screen is chosen according to the actual detection circumstances and is not limited thereto. It is preferable and more energy saving to choose to drive simultaneously several groups of channels on both sides of channel M. For example, 2-3 pairs of channels which are adjacent to channel M may be chosen, but it is not limited thereto.

Step 53: self-capacitance touch screen coordinate data for a touch in the currently detected channel is calculated.

Even if the self-capacitance touch screen suffers from the influence of water vapor or a water droplet, the voltage across channel M equivalent capacitance generated due to water will not lead to a voltage difference as channel M receives the high frequency alternating current voltage, namely there is no charge transfer happened. That is to say the equivalent capacitance does not disturb the detection actually. Therefore, in the case that the channel of the self-capacitance touch screen is detected, the disturbance of water to the detection of the touch screen can be avoided by using the method in this embodiment. Secondly, since the voltage difference across the capacitance between the currently detected channel of the self-capacitance touch screen and an adjacent scanning channel also dose not change, the initial capacitance of the currently detected channel of the self-capacitance touch screen to the ground is decreased, and the relative change of the capacitance to the ground generated due to the same touch is increased, thereby the detection sensibility of the self-capacitance touch screen is improved.

FIG. 6 shows another detection method for a capacitive touch screen which includes the following steps.

Step 61: a currently detected channel of a self-capacitance touch screen receives a scanning waveform.

Step 62: the voltage of the scanning waveform is input into an input terminal of a voltage following unit, and all the channels of the self-capacitance touch screen except the currently detected channel of the self-capacitance touch screen is driven via an output terminal of the voltage following unit.

The difference between the present embodiment and the previous embodiment lies in that the scanning waveform of the output terminal of the voltage following unit is connected to all the channels of the self-capacitance touch screen except the currently detected channel of the self-capacitance touch screen. While a high frequency alternating current voltage is send to the currently detected channel of the self-capacitance touch screen to implement the detection of a touch, the disturbance of water vapor or a water droplet is also avoided. In consideration of power consumption, the previous embodiment may not synchronously drive all the channels of the self-capacitance touch screen except the currently detected channel of the self-capacitance touch screen.

Step 63: self-capacitance touch screen coordinate data for a touch in the currently detected channel is calculated.

In this embodiment, when the voltage following unit is an amplifier whose magnification factor is 1:

an in-phase terminal of the amplifier is connected to the currently detected channel of the self-capacitance touch screen; and

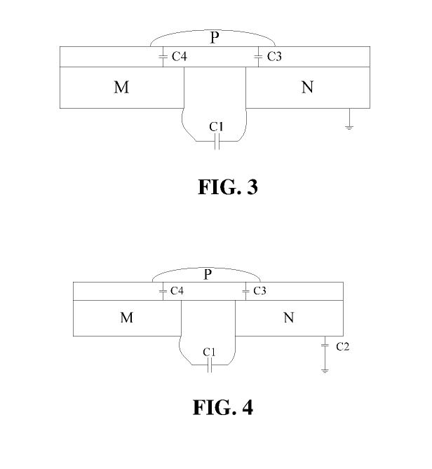

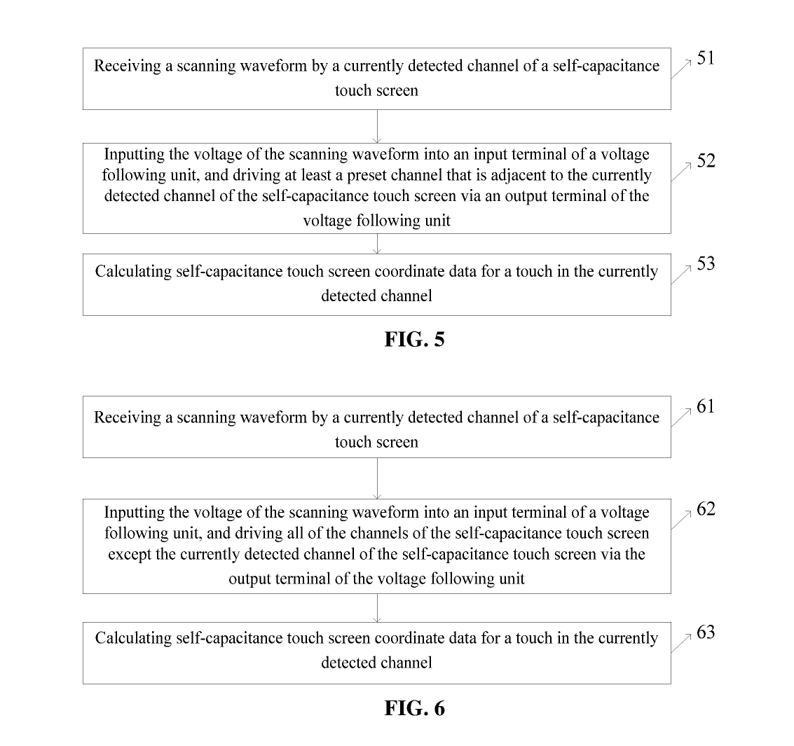

a reversed-phase terminal of the amplifier is connected to an output terminal of the amplifier and is connected at the same time to at least the preset channel that is adjacent to the currently detected channel of the self-capacitance touch screen, description will be given in conjunction with FIG. 8. More specifically, the amplifier is an amplifier whose magnification factor is nearly 1, so as to ensure that the value of the input voltage is equal to the value of the output voltage. When the channel M is detected currently, the scanning waveform for the channel M drives (some or all of) the other channels via a voltage follower. The currently scanned channel and (some or all of) the other channels change at the same time and have the same voltage, that is, the voltage difference across the equivalent capacitance formed by capacitance C3 in series with capacitance C4 in the FIGS. 3-4 does not change and there is no charge transfer. For the channel M, the capacitance C3 and the capacitance C4 no longer bring in an equivalent capacitance to the ground, that is to say the capacitance to the ground caused by water is avoided. Similarly, the parasitic capacitance between the currently scanned channel and an adjacent scanned channel (such as capacitance C1 in FIG. 3, or the equivalent capacitance formed by capacitance C1 in series with capacitance C2 in FIG. 4) is no longer a capacitance to the ground. Thereby the initial capacitance of each channel to the ground is decreased, and the relative change generated due to the same touch is increased, thereby the detection sensibility is improved.

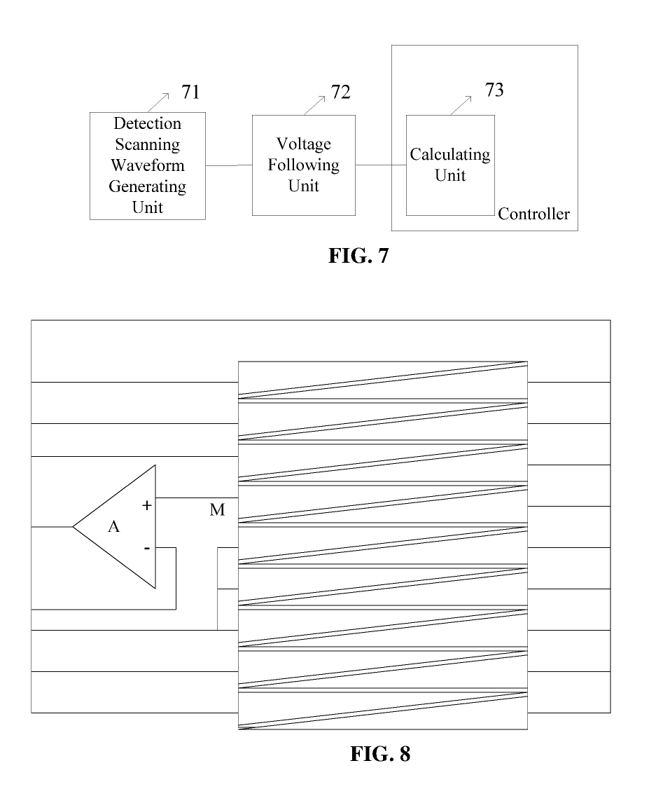

FIG. 7 shows a detection device for a capacitive touch screen which includes:

a detection scanning waveform generating unit 71 configured to send a scanning waveform to a currently detected channel of a self-capacitance touch screen;

a voltage following unit 72, wherein a voltage of a scanning waveform is input into an input terminal of the voltage following unit, an output terminal of the voltage following unit is connected to at least a preset channel that is adjacent to the currently detected channel of the self-capacitance touch screen, and the voltage following unit is configured to drive the preset channel that is adjacent to the currently detected channel of the self-capacitance touch screen by utilizing the scanning waveform;

wherein the number of the voltage following unit is single in the present embodiment,

a calculating unit 73 configured to calculate self-capacitance touch screen coordinate data for a touch in the currently detected channel.

The voltage following unit can also be preferably connect to a channel of the self-capacitance touch screen in the following way:

the output terminal of the voltage following unit is connected to all the channels of the self-capacitance touch screen except the currently detected channel of the self-capacitance touch screen.

It is needed to explain that:

the calculating unit may be embedded into a controller (or a microprocessor), as shown in FIG. 7, there is no limitation to the type of the controller, the calculating algorithm may be directly implemented by a hardware or a soft module executed by a processor or the combination thereof. The soft module may be set in a random access memory (RAM), a memory, a read-only memory (ROM), an electrically programmable ROM, an electrically erasable programmable ROM, a register, a hard disk, a removable disk, a CD-ROM or a storage medium of any other form known in the technical field.

The embodiments of the device descried above are only illustrative, Wherein a unit described as separated components may be or not be separated physically, and a component shown as a unit may be or not be a physical unit, that is to say it may be located in one position or may be distributed on multiple network units. Some or all of the units may be chosen to achieve the object of the embodiment as required actually.

Preferably, the voltage following unit may be an amplifier whose magnification factor is 1 and a specific implement can be referred to FIG. 8.

It is needed to specially point out that the present invention further discloses a detection system for a self-capacitance touch screen, which includes the detection device shown in FIG. 7 and corresponding to the explanation for FIG. 7. The detection system may further include other modules or devices used in cooperation with the detection device. The specific form of the system will not be illustrated due to difference in the configuration of the detection system. Moreover, the function and structure of the detection device may be referred to illustrations of FIGS. 7-8 and the corresponding explanation for FIGS. 7-8.

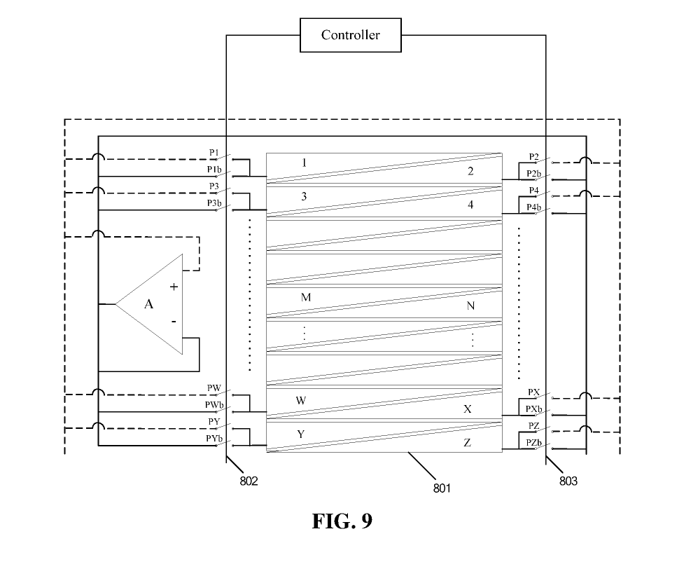

FIG. 9 is a schematic diagram that a voltage following unit A of the detection device for the capacitive touch screen detects channels provided by an embodiment of the present invention. As shown in the figure, the channels of the touch screen 801 include detection channel 1 to detection channel Z. The input terminal of the voltage following unit A is connected to each detection channel through switch P1, P2 . . . PZ, and the output terminal of the voltage following unit is connected to each detection channel through switch P1b, P2b . . . PZb. A controller controls all switches P1, P2 . . . PZ and P1b, P2b . . . PZb to make them turn-on or turn-off through two control lines 802 and 803. In the present embodiment, PX represents any one switch among P1, P2 . . . PZ and PXb represents any one switch among P1b, P2b . . . PZb. A control signal received by PXb is reverse to a control signal received by PX, that is, when PX receives a turn-on signal, PXb receives a turn-off signal, and vice versa. Each time the controller provides one turn-on signal for a PX switch. When the PX switch receives the channel signal of turn-on, it indicates that the PX channel is currently being detected. And the channel that the PX switch corresponds to is connected to the input terminal of the voltage following unit A, and other channels are connected to the output terminal of the voltage following unit A. As an example of channel M, if switch PM receives the turn-on signal provided by the controller, switch PM turns on, and switch PMb turns off; all other PX switches except switch PM turn off, and all other PXb switches except switch PMb turn on; so that channel M is connected to the input terminal of the voltage following unit A, and other channels are connected to the output terminal of the voltage following unit A, as shown in FIG. 8.

In general:

in the detection method, device and system according to the embodiments of the present invention, when a current channel is detected, its scanning waveform drives at least the preset channel that is adjacent to the currently detected channel of the self-capacitance touch screen via the voltage following unit. The voltage of the currently detected channel and the voltage of each channel in the region which is disturbed by water change simultaneously. When the self-capacitance touch screen suffers from the disturbance generated due to the water vapor or a water droplet, the voltage difference across the equivalent capacitance increment ΔC of the currently detected channel generated due to disturbance by water vapor or the water droplet does not change. That is to say that the influence generated due to the equivalent capacitance to the ground during the detection is no longer introduced, thereby the disturbance to the detection for a touch in the currently detected channel of the touch screen generated due to the water vapor or the water droplet is avoided. Secondly, since the voltage difference across the capacitance between the currently detected channel of the self-capacitance touch screen and an adjacent scanning channel also dose not change, the initial capacitance of the currently detected channel of the self-capacitance touch screen to the ground is decreased, and the relative change generated due to the same touch is increased, so that the detection sensibility of the self-capacitance touch screen is improved.

The embodiments of the present invention are described herein in a progressive manner, with an emphasis placed on explaining the difference between each embodiment and the other embodiments; hence, for the same or similar parts among the embodiments, they can be referred to from one another. For the device and system disclosed in the embodiments, the corresponding descriptions are relatively simple because the device and system correspond to the methods disclosed in the embodiments. The relevant portions may be referred to the description for the method parts.

The above description of the embodiments disclosed herein enables those skilled in the art to implement or use the present invention. Numerous modifications to the embodiments will be apparent to those skilled in the art, and the general principle herein can be implemented in other embodiments without deviation from the spirit or scope of the embodiments of the present invention. Therefore, the present invention will not be limited to the embodiments described herein, but in accordance with the widest scope consistent with the principle and novel features disclosed herein.

1. A detection method for a capacitive touch screen, comprising:
receiving a scanning waveform by a currently detected channel of a self-capacitance touch screen;
inputting the voltage of the scanning waveform into an input terminal of a voltage following unit, and driving at least a preset channel that is adjacent to the currently detected channel of the self-capacitance touch screen via an output terminal of the voltage following unit; and
calculating self-capacitance touch screen coordinate data for a touch in the currently detected channel.

2. The detection method according to claim 1, wherein the voltage following unit is single.

3. The detection method according to claim 1, wherein the driving a preset channel that is adjacent to the currently detected channel of the self-capacitance touch screen via an output terminal of the voltage following unit comprises:
driving all the channels of the self-capacitance touch screen except the currently detected channel of the self-capacitance touch screen via the output terminal of the voltage following unit.

4. The detection method according to claim 2, wherein the driving a preset channel that is adjacent to the currently detected channel of the self-capacitance touch screen via an output terminal of the voltage following unit comprises:
driving all the channels of the self-capacitance touch screen except the currently detected channel of the self-capacitance touch screen via the output terminal of the voltage following unit.

5. The detection method according to claim 3, wherein when the voltage following unit is an amplifier whose magnification factor is 1:
an in-phase terminal of the amplifier is connected to the currently detected channel of the self-capacitance touch screen; and
a reversed-phase terminal of the amplifier is connected to an output terminal of the amplifier and is connected at the same time to at least the preset channel that is adjacent to the currently detected channel of the self-capacitance touch screen.

6. A detection device for a capacitive touch screen, comprising:
a detection scanning waveform generating unit configured to send a scanning waveform to a currently detected channel of a self-capacitance touch screen;
a voltage following unit, wherein the voltage of the scanning waveform is input into an input terminal of the voltage following unit, an output terminal of the voltage following unit is connected to at least a preset channel that is adjacent to the currently detected channel of the self-capacitance touch screen, and the voltage following unit is configured to drive the preset channel that is adjacent to the currently detected channel of the self-capacitance touch screen by utilizing the scanning waveform; and
a calculating unit configured to calculate self-capacitance touch screen coordinate data for a touch in the currently detected channel.

7. The detection device according to claim 6, wherein the number of the voltage following unit is single.

8. The detection device according to claim 6, wherein the output terminal of the voltage following unit is connected to all the channels of the self-capacitance touch screen except the currently detected channel of the self-capacitance touch screen.

9. The detection device according to claim 6, further comprising: a controller configured to control switches of an input terminal of the voltage following unit and an output terminal of the voltage following unit between different detected channels.

10. The detection device according to claim 7, wherein the output terminal of the voltage following unit is connected to all the channels of the self-capacitance touch screen except the currently detected channel of the self-capacitance touch screen.

11. The detection device according to claim 6, wherein the voltage following unit is specifically an amplifier whose magnification factor is 1, an in-phase terminal of the amplifier is connected to the currently detected channel of the self-capacitance touch screen; and an reversed-phase terminal of the amplifier is connected to an output terminal of the amplifier and is connected at the same time to at least the preset channel that is adjacent to the currently detected channel of the self-capacitance touch screen.

12. A detection system for a self-capacitance touch screen, comprising the detection device according to claim 6.

13. A detection system for a self-capacitance touch screen, comprising the detection device according to claim 7.

14. A detection system for a self-capacitance touch screen, comprising the detection device according to claim 8.

15. A detection system for a self-capacitance touch screen, comprising the detection device according to claim 9.

16. A detection system for a self-capacitance touch screen, comprising the detection device according to claim 10.

17. A detection system for a self-capacitance touch screen, comprising the detection device according to claim 11.
